(19) United States
(12) Patent Application Publication
(10) Pub. No.: US 2018/0269459 A1
(43) Pub. Date: Sep. 20, 2018

(54) ELECTRIC STORAGE MODULE, MANUFACTURING METHOD FOR ELECTRIC STORAGE MODULE, METAL JOINED BODY, AND MANUFACTURING METHOD FOR METAL JOINED BODY

(71) Applicant: TAIYO YUDEN CO., LTD., Chuo-ku, Tokyo (JP)

(72) Inventors: Takayuki TSUCHIYA, Takasaki-shi (JP); Shinji ISHII, Takasaki-shi (JP)

(21) Appl. No.: 15/763,754

(22) PCT Filed: Jul. 11, 2016
(86) PCT No.: PCT/JP2016/070409

§ 371 Date: Mar. 27, 2018

(30) Foreign Application Priority Data
Oct. 1, 2015 (JP) 2015-196034
Nov. 17, 2015 (JP) 2015-224448

(51) Int. Cl. H01M 2/26; H01R 4/62; H01G 11/76; H01G 11/84; H01R 43/02; H01M 10/0525; H01M 2/04; H01M 2/10; H01M 2/20

(52) U.S. Cl. CPC H01M 2/26; H01R 4/625; H01G 11/76; H01G 11/84; H01G 11/10; H01M 10/0525; H01M 2/04; H01M 2/10; H01M 2/202; H01R 43/0221

(57) ABSTRACT

An electric storage module includes an electric storage cell and a frame. The electric storage cell includes: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode. The frame forms a housing space in which the electric storage cell is housed, and has a bus bar made of the second metal material. The positive electrode tab and the bus bar are joined to each other by welding, and a mixed-material part where the first metal material and the second metal material are mixed together is formed at the interface between the positive electrode tab and the bus bar.

### TECHNICAL FIELD

The present invention relates to an electric storage module with built-in electric storage cell, a manufacturing method for an electric storage module, a metal joined body, and a manufacturing method for metal joined body.

### BACKGROUND ART

Electric storage modules of a type where a battery, capacitor, or other electric storage cell is integrally housed in an enclosure together with a control circuit, are widely available. They are generally constituted so that the positive electrode and negative electrode of the electric storage cell are joined with screws to the bus bar in the enclosure and thus electrically connected to the terminals of the electric storage module via the bus bar (refer to Patent Literature 1, for example).

On the other hand, there is a demand for electric storage modules offering higher capacity and for ways to accommodate large current at the electrical connection between the electric storage cell and the bus bar. When the contact resistance at this electrical connection increases, heat generation presents problems. Accordingly, electric storage modules characterized by the positive electrode and negative electrode of the electric storage cell being welded to the bus bar to reduce the contact resistance and improve the connection strength, are also available.

Background Art Literature Patent Literature
Patent Literature 1: Japanese Patent Laid-open No. 2014-229564

### SUMMARY OF THE INVENTION

### Problems to be Solved by the Invention

However, some electric storage cells, such as lithium ion capacitors, etc., developed in recent years, use different materials for the positive electrode and the negative electrode. This means that the material of at least one of the positive electrode and the negative electrode is different from the material of the bus bar. When different types of metals are welded together, an intermetallic compound is formed at the interface, which makes welding difficult.

In light of the aforementioned situations, an object of the present invention is to provide an electric storage module whose electric storage cell and bus bar have low contact resistance as well as excellent connection strength between them, a manufacturing method for an electric storage module, a metal joined body, and a manufacturing method for a metal joined body.

### Means for Solving the Problems

To achieve the aforementioned object, the electric storage module pertaining to an embodiment of the present invention comprises an electric storage cell and a frame.

The electric storage cell comprises: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode.

The frame forms a housing space in which the electric storage cell is housed, and has a bus bar made of the second metal material.

The positive electrode tab and the bus bar are joined to each other by means of welding, and a mixed-material part where the first metal material and the second metal material are mixed together is formed at the interface between the positive electrode tab and the bus bar.

According to this constitution, an anchor effect is produced by the mixed-material part at the interface between the positive electrode tab and the bus bar, each of which is made of a different metal material, and consequently a strong bond is formed between the positive electrode tab and the bus bar at their interface. In general, welding together different metal materials causes a metal compound to form as a result of combining the different materials, and the joining strength between them becomes insufficient; according to the aforementioned constitution, however, sufficient joining strength is ensured between the positive electrode tab and the bus bar because of the mixed-material part.

To achieve the aforementioned object, the electric storage module according to an embodiment of the present invention comprises an electric storage cell and a frame.

The electric storage cell comprises: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode.

The frame forms a housing space in which the electric storage cell is housed, and has a bus bar made of the first metal material.

The negative electrode tab and the bus bar are joined to each other by means of welding, and a mixed-material part where the first metal material and the second metal material are mixed together is formed at the interface between the negative electrode tab and the bus bar.

According to this constitution, an anchor effect is produced by the mixed-material part at the interface between the negative electrode tab and the bus bar, each of which is made of a different metal material, and consequently a strong bond is formed between the negative electrode tab and the bus bar at their interface.

The first metal material may be aluminum, and the second metal material may be copper.

Lithium ion capacitors and lithium ion secondary batteries have their positive electrode tab and negative electrode tab made of different metal materials, respectively, because forming the positive electrode tab and the negative electrode tab with the same metal material causes one of them to melt due to electrochemical action. To be specific, aluminum may be used for the positive electrode tab, and copper may be used for the negative electrode tab.

To achieve the aforementioned object, the manufacturing method for an electric storage module pertaining to an embodiment of the present invention comprises:
housing an electric storage cell comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar; and
irradiating a high energy beam onto the positive electrode tab along a scanning path in which the center moves in one direction and which includes a path that moves in the direction opposite the moving direction of the center, to weld the positive electrode tab to the bus bar.

According to this manufacturing method, the positive electrode tab and the bus bar are welded together several times within a short period of time in the same region or adjacent regions; as a result, it becomes possible to form, at the interface between the positive electrode tab and the bus bar, a mixed-material part where the first metal material and the second metal material are mixed together.

To achieve the aforementioned object, the manufacturing method for an electric storage module pertaining to an embodiment of the present invention comprises:
housing an electric storage cell comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar; and
irradiating a high energy beam onto the positive electrode tab along a scanning path that draws arcs in which the center of the arcs moves in one direction, to weld the positive electrode tab to the bus bar.

According to this manufacturing method, since the welded area between the positive electrode tab and the bus bar increases, and they are welded together several times within a short period of time in the same region or adjacent regions, it becomes possible to form, at the interface between the positive electrode tab and the bus bar, a mixed-material part where the first metal material and the second metal material are mixed together.

To achieve the aforementioned object, the manufacturing method for an electric storage module pertaining to an embodiment of the present invention comprises:
housing an electric storage cell comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the first metal material, in such a way that the negative electrode tab contacts the bus bar; and
irradiating a high energy beam onto the negative electrode tab along a scanning path in which the center moves in one direction and which includes a path that moves in the direction opposite the moving direction of the center, to weld the negative electrode tab to the bus bar.

According to this manufacturing method, the negative electrode tab and the bus bar are welded together several times within a short period of time in the same region or adjacent regions; as a result, it becomes possible to form, at the interface between the negative electrode tab and the bus bar, a mixed-material part where the first metal material and the second metal material are mixed together.

To achieve the aforementioned object, the manufacturing method for an electric storage module pertaining to an embodiment of the present invention comprises:
housing an electric storage cell comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the first metal material, in such a way that the negative electrode tab contacts the bus bar; and
irradiating a high energy beam onto the negative electrode tab along a scanning path that draws arcs in which the center of the arcs moves in one direction, to weld the negative electrode tab to the bus bar.

According to this manufacturing method, the welded area between the negative electrode tab and the bus bar increases, while they are welded together several times within a short period of time in the same region or adjacent regions; as a result, it becomes possible to form, at the interface between the negative electrode tab and the bus bar, a mixed-material part where the first metal material and the second metal material are mixed together.

To achieve the aforementioned object, the metal joined body pertaining to an embodiment of the present invention comprises a first member and a second member.

The first member is made of a first metal material.

The second member is made of a second metal material which is different from the first metal material.

The first member and the second member are joined to each other by means of welding, and at the interface between the first member and the second member, the second metal material penetrates into the first metal material in an irregular manner.

According to this constitution, an anchor effect is produced between the first member and the second member, each of which is made of a different metal material, because the second metal material penetrates into the first metal material in an irregular manner, and consequently a strong bond is formed at the interface between the first member and the second member and therefore sufficient joining strength is ensured between the first member and the second member.

The first metal material may be a metal material whose melting point is lower than the melting point of the second metal material.

The aforementioned structure can be formed by means of welding using a high energy beam, and when the melting point of the first metal material is lower than the melting point of the second metal material, the second metal material penetrates easily into the molten pool formed by the first member, and it is favorable as it facilitates the formation of the above structure.

The first metal material may be aluminum, and the second metal material may be copper.

To achieve the aforementioned object, the manufacturing method for a metal joined body pertaining to an embodiment of the present invention comprises:
holding a first member made of a first metal material, and second metal material which is different from the first metal material, in contact with each other; and
irradiating a high energy beam onto the first member along a scanning path in which the center moves in one direction and which includes a path that moves in the direction opposite the moving direction of the center, to weld the first member to the second member.

By irradiating a high energy beam onto the first member along a scanning path in which the center moves in one direction and which includes a path that moves in the direction opposite the moving direction of the center, the first member and the second member are welded together several times within a short period of time in the same region or adjacent regions, which agitates the molten pool of the first metal material and forms a structure where the softened or molten surface layer part of the second metal material penetrates into the first metal material in an irregular manner.

In the step to weld the first member to the second member, a high energy beam may be irradiated onto the first member along a scanning path that draws arcs in which the center of the arcs moves in one direction.

According to this manufacturing method, since the welded area between the first member and the second member increases, and they are welded together several times within a short period of time in the same region or adjacent regions, the molten pool of the first metal material is agitated and a structure where the softened or molten surface layer part of the second metal material penetrates into the first metal material in an irregular manner is formed.

The first metal material may be a metal material whose melting point is lower than the melting point of the second metal material.

When the melting point of the first metal material is lower than the melting point of the second metal material, the second metal material penetrates easily into the molten pool formed by the first member when the high energy beam is irradiated onto the first member, which is favorable as it facilitates the formation of the above structure.

The high energy beam may be a light irradiated from a fiber laser.

A fiber laser can draw a continuous trajectory, and laser scanning can be performed along a scanning path in which the center moves in one direction and which includes a path that moves in the direction opposite the moving direction of the center.

To achieve the aforementioned object, the manufacturing method for an electric storage module pertaining to an embodiment of the present invention comprises:
housing an electric storage cell comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar;
irradiating a high energy beam onto the positive electrode tab to form, on the positive electrode tab, a molten pool constituted by the first metal material in molten state, and also to soften the second metal material in the locations of the bus bar where it contacts the molten pool; and
irradiating a high energy beam onto the positive electrode tab to agitate the molten pool, and mix the softened second metal material into the molten pool.

According to this manufacturing method, the second metal material constituting the bus bar penetrates in an irregular manner into the first metal material constituting the positive electrode tab, to form a strong bond between the positive electrode tab and the bus bar due to an anchor effect, and consequently sufficient joining strength can be ensured between the positive electrode tab and the bus bar.

To achieve the aforementioned object, the manufacturing method for a metal joined body pertaining to an embodiment of the present invention comprises:
holding a first member made of a first metal material, and a second metal material which is different from the first metal material, in contact with each other;
irradiating a high energy beam onto the first member to form, on the first member, a molten pool constituted by the first metal material in molten state, and also to soften the second metal material in the locations of the second member where it contacts the molten pool; and
irradiating a high energy beam onto the first member to agitate the molten pool, and mix the softened second metal material into the molten pool.

According to this manufacturing method, the second metal material constituting the second member penetrates in an irregular manner into the first metal material constituting the first member, to form a strong bond between the first member and the second member due to an anchor effect, and consequently sufficient joining strength can be ensured between the first member and the second member.

### Effects of the Invention

As described above, according to the present invention, a metal joined body, an electric storage module whose electric storage cell and bus bar have low contact resistance as well as excellent connection strength between them, a manufacturing method for an electric storage module, and a manufacturing method for a metal joined body, can be provided.

### BRIEF DESCRIPTION OF THE DRAWINGS

FIG. 1 A perspective view of the electric storage module pertaining to an embodiment of the present invention.

FIG. 2 An exploded perspective view of the same electric storage module.

FIG. 3 A schematic view showing the constitution of the frame the same electric storage module has.

FIG. 4 A plan view of the frame the same electric storage module has.

FIG. 5 A plan view of the frame the same electric storage module has.

FIG. 6 A plan view of the frame the same electric storage module has.

FIG. 7 A perspective view of an electric storage cell the same electric storage module has.

FIG. 8 A cross-sectional view of an electric storage cell the same electric storage module has.

FIG. 9 A plan view of the frame and electric storage cells the same electric storage module has.

FIG. 10 A cross-sectional view of the frame and electric storage cells the same electric storage module has.

FIG. 11 A schematic view showing the connection relationships of the electric storage cells and bus bars in the same electric storage module.

FIG. 12 A plan view of the locations where an electric storage cell and a bus bar are welded together in the same electric storage module.

FIG. 13 An enlarged view of a location where an electric storage cell and a bus bar are welded together in the same electric storage module.

FIG. 14 A schematic view showing a laser scanning path along which an electric storage cell and a bus bar are welded together in the same electric storage module.

FIG. 15 A schematic view showing a laser scanning path along which an electric storage cell and a bus bar are welded together in the same electric storage module.

FIG. 16 A cross-sectional view of a location where an electric storage cell and a bus bar are welded together in the same electric storage module.

FIG. 17 A schematic view showing an intermetallic compound produced by welding different types of metal materials.

FIG. 18 A schematic view showing a laser scanning path along which an electric storage cell and a bus bar are welded together in the same electric storage module.

FIG. 19 A cross-sectional view of the metal joined body pertaining to an embodiment of the present invention.

FIG. 20 A schematic view showing the welding process for the same metal joined body.

FIG. 21 A cross-sectional view of the metal joined body pertaining to an embodiment of the present invention.

FIG. 22 A schematic view showing the welding process for the same metal joined body.

### MODE FOR CARRYING OUT THE INVENTION

The electric storage module pertaining to an embodiment of the present invention is explained.

[Constitution of Electric Storage Module]

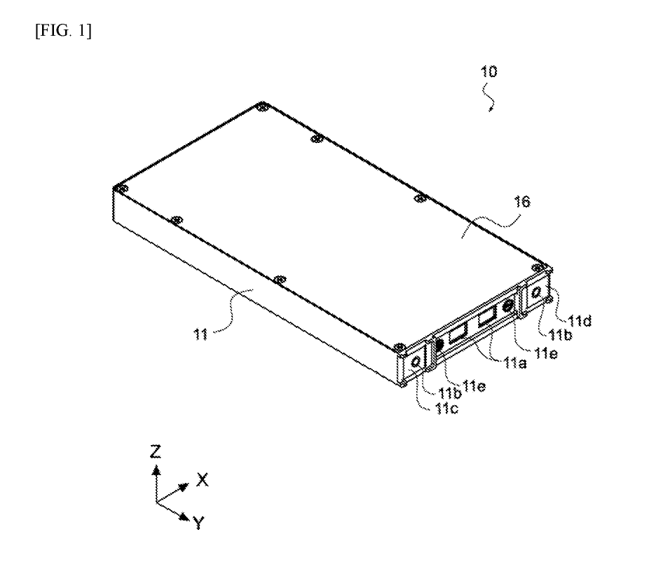

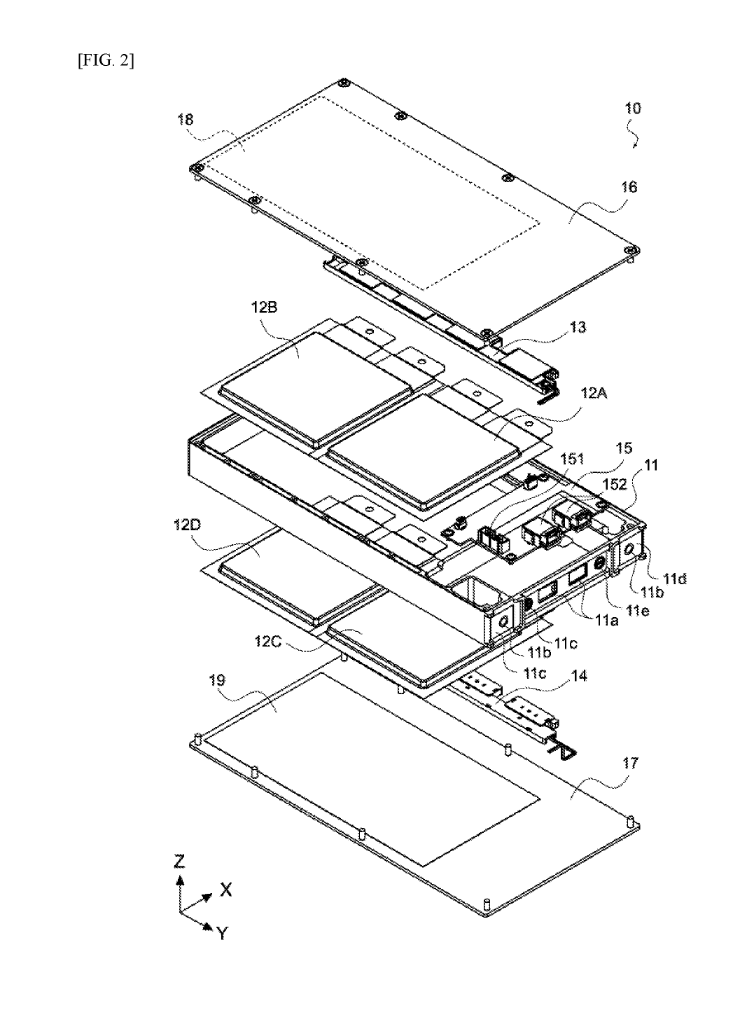

FIG. 1 is a perspective view of an electric storage module 10 pertaining to this embodiment, while FIG. 2 is an exploded perspective view of the electric storage module 10. It should be noted that, in the drawings cited below, the X direction, Y direction, and Z direction represent three directions that are orthogonal to one another.

As shown in FIGS. 1 and 2, the electric storage module 10 comprises a frame 11, electric storage cells 12 (12A to 12D), a first voltage detection board 13, a second voltage detection board 14, a connector board 15, a first plate 16, a second plate 17, a first heat-transfer insulation sheet 18, and a second heat-transfer insulation sheet 19. The electric storage module 10 has four electric storage cells 12, where these electric storage cells 12 are referred to as electric storage cell 12A, electric storage cell 12B, electric storage cell 12C and electric storage cell 12D, respectively.

The frame 11 is a hollow, frame-like member and forms a space for housing the electric storage cells 12. As shown in FIGS. 1 and 2, connector holes 11a, screw holes 11b, a positive-electrode terminal 11c, a negative-electrode terminal 11d, and polarity markings 11e, are provided on one side of the frame 11. Two connector holes 11a are provided in the frame 11, but one, three, or more connector holes 11a may be provided instead.

Two screw holes 11b are provided in the frame 11, and the positive-electrode terminal 11c and the negative-electrode terminal 11d are provided around the screw holes 11b, respectively. One polarity marking 11e is provided near the positive-electrode terminal 11c, and another near the negative-electrode terminal 11d, where each marking indicates the polarity (+ or −) of the positive-electrode terminal 11c or the negative-electrode terminal 11d.

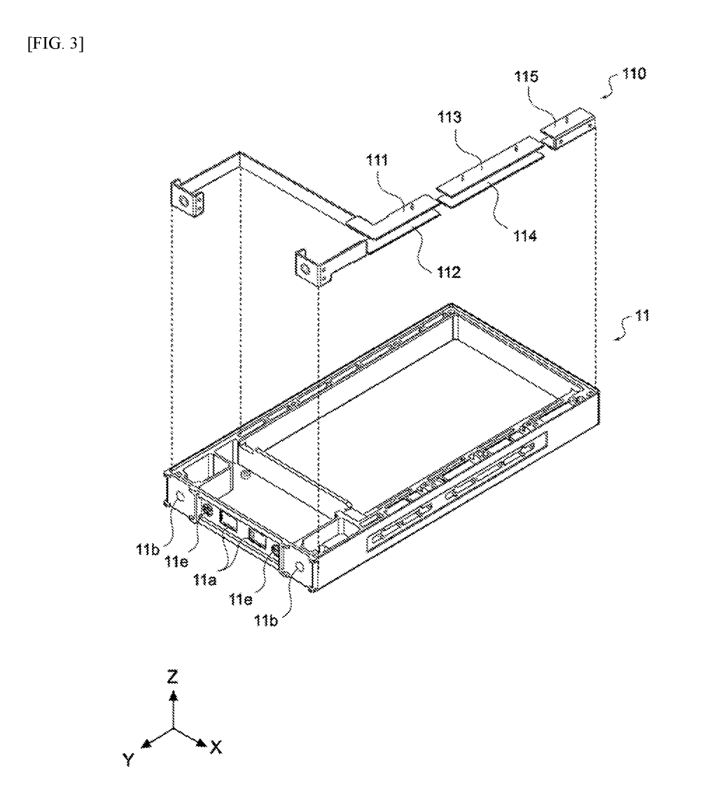

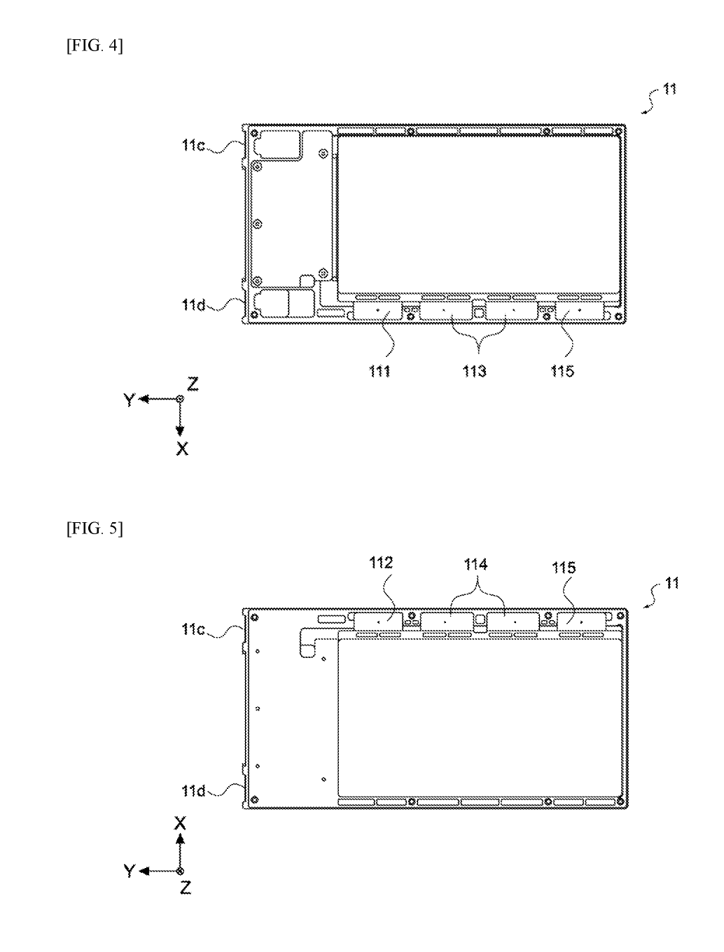

The frame 11 is formed by insert molding and constituted by a resin member made of synthetic resin and bus bars 110 embedded therein. FIG. 3 is a schematic view of the frame 11 and the bus bar 110, while FIGS. 4 to 6 are plan views showing the frame 11 from different directions.

As shown in these figures, the bus bars 110 include five bus bars, including a first bus bar 111, a second bus bar 112, a third bus bar 113, a fourth bus bar 114, and a fifth bus bar 115. The bus bars are embedded in the frame 11 in a manner keeping distance from each other, and are partially exposed from the frame 11.

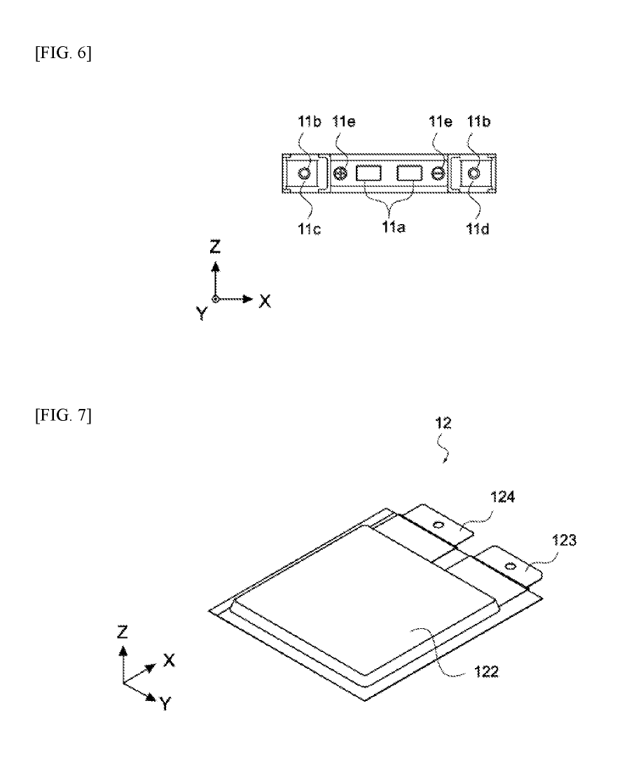

The first bus bar 111 is exposed on the top face side (first plate 16 side) of the frame 11, as shown in FIG. 4, and also exposed around one screw hole 11b, as shown in FIG. 6, to form the positive-electrode terminal 11c. The second bus bar 112 is exposed on the bottom face side (second plate 17 side) of the frame 11, as shown in FIG. 5, and also exposed around the other screw hole 11b, as shown in FIG. 6, to form the negative-electrode terminal 11d.

The third bus bar 113 is exposed at two locations on the top face side of the frame 11, as shown in FIG. 4, while the fourth bus bar 114 is exposed at two locations on the bottom face side of the frame 11, as shown in FIG. 5. The fifth bus bar 115 is exposed on the top face side, and the bottom face side, of the frame 11, as shown in FIGS. 4 and 5.

The bus bars 110 may be made of copper. Or, the bus bars 110 may be made of other highly conductive metal material.

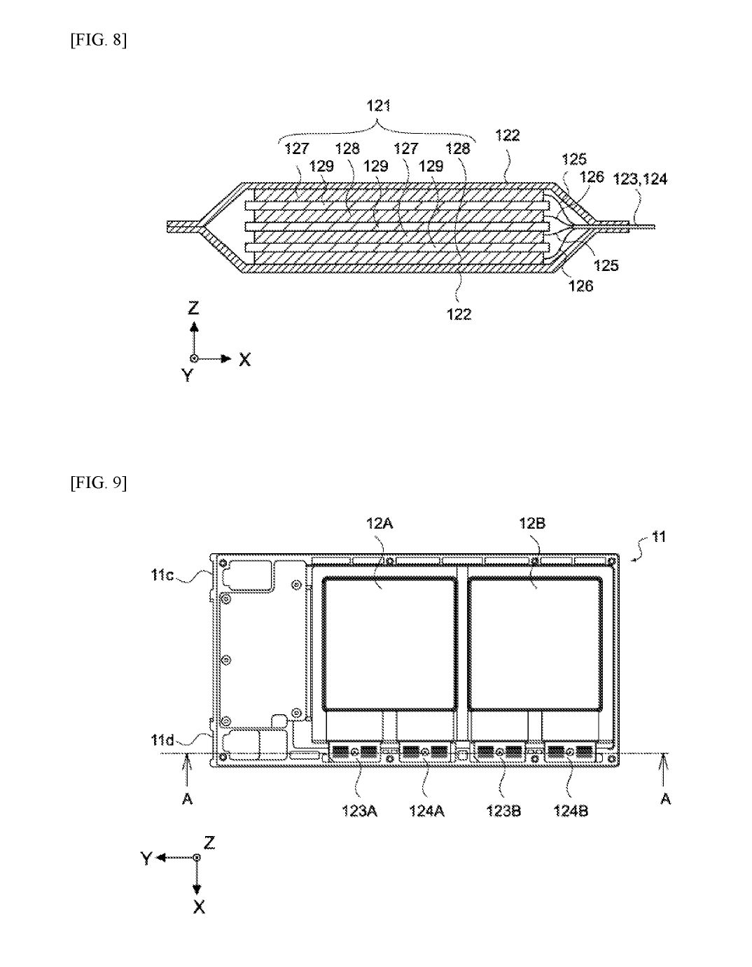

The electric storage cells 12 (12A to 12D) are cells capable of storing and discharging electricity, and are lithium ion capacitors, lithium ion secondary batteries, or the like. FIG. 7 is a perspective view of an electric storage cell 12, while FIG. 8 is a cross-sectional view of an electric storage cell 12.

As shown in these figures, the electric storage cell 12 has an electric storage element 121, covering films 122, a positive electrode tab 123, a negative electrode tab 124, positive electrode conductors 125, and negative electrode conductors 126.

The electric storage element 121 comprises positive electrodes 127, negative electrodes 128, and separators 129, and the positive electrodes 127 and the negative electrodes 128 are stacked alternately together, with the separators 129 in between.

Each positive electrode 127 contains a positive-electrode active material, and is constituted by layers of the positive-electrode active material attached on both the top face and the bottom face of a positive-electrode collector made of metal. The positive-electrode active material is an activated carbon, for example, but what constitutes the positive-electrode active material may be changed as deemed appropriate depending on the type of the electric storage cell 12.

Each negative electrode 128 contains a negative-electrode active material, and is constituted by layers of the negative-electrode active material attached on both the top face and the bottom face of a negative-electrode collector made of metal. The negative-electrode active material is a carbon material, for example, but what constitutes the negative-electrode active material may be changed as deemed appropriate depending on the type of the electric storage cell 12.

Each separator 129 is placed between a positive electrode 127 and a negative electrode 128, to prevent contact between (insulate) the positive electrode 127 and the negative electrode 128, while allowing an electrolyte to pass through it. The separator 129 may be a woven fabric, non-woven fabric, synthetic resin microporous membrane, etc., for which a cellulose or polyolefin material can be used.

The number of the positive electrodes 127 and negative electrodes 128 constituting the electric storage element 121 is not limited in any way, so long as the constitution is such that the positive electrodes 127 and the negative electrodes 128 are stacked alternately together, with the separators 129 in between.

The electric storage element 121 is sealed, together with an electrolyte, by the covering films 122. The electrolyte is not limited in any way, and may be changed as deemed appropriate depending on the type of the electric storage cell 12. The covering films 122 may be laminate films, each constituted by layers of a synthetic resin attached on both the top and the bottom of a metal foil, and two covering films 122 are fused together along the peripheral border of the electric storage element 121 to seal the inside.

The positive electrode tab 123 and the negative electrode tab 124 are sandwiched between the covering films 122, with the tabs kept apart from each other. The positive electrode tab 123 is electrically connected to the positive electrodes 127 via positive electrode conductors 125 that are wires or foils, while the negative electrode tab 124 is electrically connected to the negative electrodes 128 via negative electrode conductors 126 that are wires or foils.

The positive electrode tab 123 and the negative electrode tab 124 are each made of a different metal material. To be specific, the positive electrode tab 123 may be made of aluminum, while the negative electrode tab 124 may be made of copper. The reason for the above is that, when the electric storage cell 12 is a lithium ion capacitor or lithium ion secondary battery, either the positive electrode tab 123 or the positive electrode tab 124 will melt due to an electrochemical action if both tabs are made of the same metal material.

As shown in FIG. 2, the electric storage cells 12 (12A, 12B) on the first plate 16 side, and the electric storage cells 12 (12C, 12D) on the second plate 17 side, are both stacked in the Z direction and housed in the electric storage module 10. The electric storage module 10 may be a type having four electric storage cells 12, but the electric storage module configuration is not limited to the foregoing and there may be one or more electric storage module sets, where each set consists of two electric storage modules 10 stacked in the Z direction. This means that, for electric storage modules 10, an even number of electric storage modules 10 may be provided.

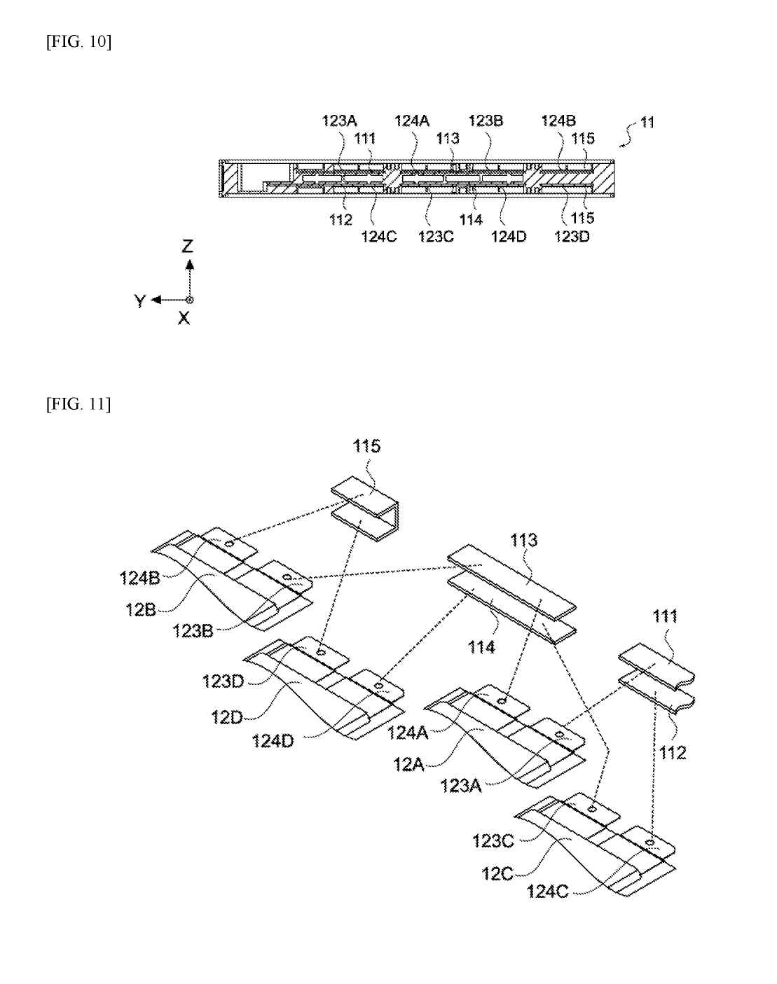

The positive electrode tab 123 and the negative electrode tab 124 of each electric storage cell 12 are connected to the positive-electrode terminal 11c and the negative-electrode terminal 11d, respectively, via the bus bars 110. FIG. 9 is a plan view showing electric storage cells 12 housed in the frame 11. FIG. 10 is a cross-sectional view showing electric storage cells 12 housed in the frame 11, corresponding to a cross-sectional view along line A-A in FIG. 9. FIG. 11 is a schematic view showing the connection relationships of the positive electrode tab 123 and negative electrode tab 124 of each electric storage cell 12, and bus bars 110.

As shown in FIG. 11, the positive electrode tab 123A of the electric storage cell 12A is connected to the first bus bar 111, while the negative electrode tab 124A of the electric storage cell 12A is connected to the third bus bar 113. The positive electrode tab 123B of the electric storage cell 12B is connected to the third bus bar 113, while the negative electrode tab 124B of the electric storage cell 12B is connected to the fifth bus bar 115.

Also, the positive electrode tab 123C of the electric storage cell 12C is connected to the fourth bus bar 114, while the negative electrode tab 124C of the electric storage cell 12C is connected to the second bus bar 112. The positive electrode tab 123D of the electric storage cell 12D is connected to the fifth bus bar 115, while the negative electrode tab 124D of the electric storage cell 12D is connected to the fourth bus bar 114. Details on how the positive electrode tab 123 and negative electrode tab 124 of each electric storage cell 12 are connected to each bus bar, are described later.

The first voltage detection board 13 monitors the voltages of the electric storage cells 12 (12A, 12B) on the first plate 16 side. The first voltage detection board 13 is fixed to the frame 11, and is electrically connected to the positive electrode tabs 123 and negative electrode tabs 124 of the electric storage cells 12A and 12B.

The second voltage detection board 14 monitors the voltages of the electric storage cells 12 (12C, 12D) on the second plate 17 side. The second voltage detection board 14 is fixed to the frame 11, and is electrically connected to the positive electrode tabs 123 and negative electrode tabs 124 of the electric storage cells 12C and 12D.

The connector board 15 has a connector 151, connectors 152, and a signal processing circuit, etc. The connector 151 is connected to the first voltage detection board 13 and the second voltage detection board 14 via wires, and receives the voltage detected at each electric storage cell 12. The connectors 152 are inserted into the connector holes 11a, to which external equipment used for inspection are connected.

The first plate 16 is a flat-shaped member made of aluminum or other metal material, and is joined to the frame 11. The first plate 16 may be a type which is screwed to the frame 11 using screws, but it may be joined to the frame 11 by other fixing methods.

The second plate 17 is a flat-shaped member made of aluminum or other metal material, and is joined to the frame 11. The second plate 17 may be a type which is screwed to the frame 11 using screws, but it may be joined to the frame 11 by other fixing methods.

The first heat-transfer insulation sheet 18 is a sheet-shaped member attached to the first plate 16, and is made of a material exhibiting high thermal conductivity and insulation property. Once the first plate 16 is fixed to the frame 11, the first heat-transfer insulation sheet 18 is sandwiched between the electric storage cells 12 (12A, 12B) on the first plate 16 side and the first plate 16, to transfer the heat from these electric storage cells 12 to the first plate 16.

The second heat-transfer insulation sheet 19 is a sheet-shaped member attached to the second plate 17, and is made of a material exhibiting high thermal conductivity and insulation property. Once the second plate 17 is fixed to the frame 11, the second heat-transfer insulation sheet 19 is sandwiched between the electric storage cells 12 (12C, 12D) on the second plate 17 side and the second plate 17, to transfer the heat from these electric storage cells 12 to the second plate 17.

[Connection of Electric Storage Cells and Bus Bars]

As described above, the positive electrode tab 123 and negative electrode tab 124 of each electric storage cell 12 are connected to bus bars 110. Since the positive electrode tab 123 and the negative electrode tab 124 are each made of a different metal material, at least one of them is made of a metal material different from what the bus bars 110 are made of. To be specific, the bus bars 110 may be made of copper, while the positive electrode tab 123 may be made of aluminum.

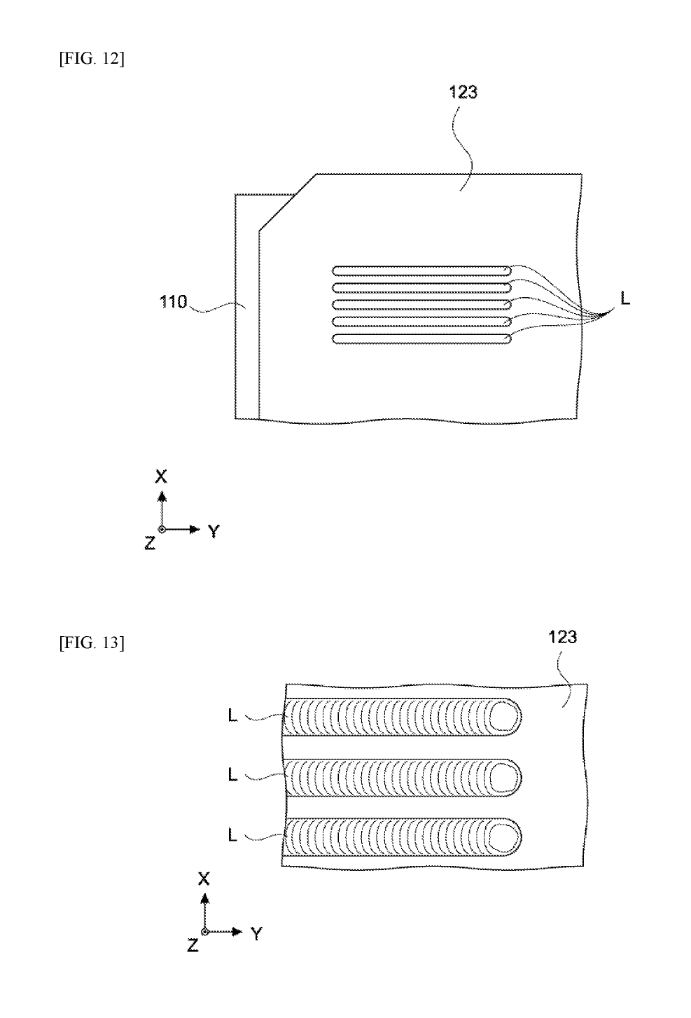

Here, in the electric storage module 10, the positive electrode tabs 123 and negative electrode tabs 124 are each welded to a bus bar 110 (one of the first bus bar 111 through the fifth bus bar 115) by means of laser welding. FIG. 12 is a schematic view showing a location where a positive electrode tab 123 and a bus bar 110 are welded together, while FIG. 13 is an enlarged view of the same welding location.

As shown in FIG. 12, the positive electrode tab 123 has multiple weld marks L formed on it, and the weld marks L as shown in FIG. 13 are formed as circular arc shapes that are arranged successively in one direction. It should be noted that the number of weld marks L is not limited in any way, and any number may be selected as deemed appropriate depending on the weld surface area.

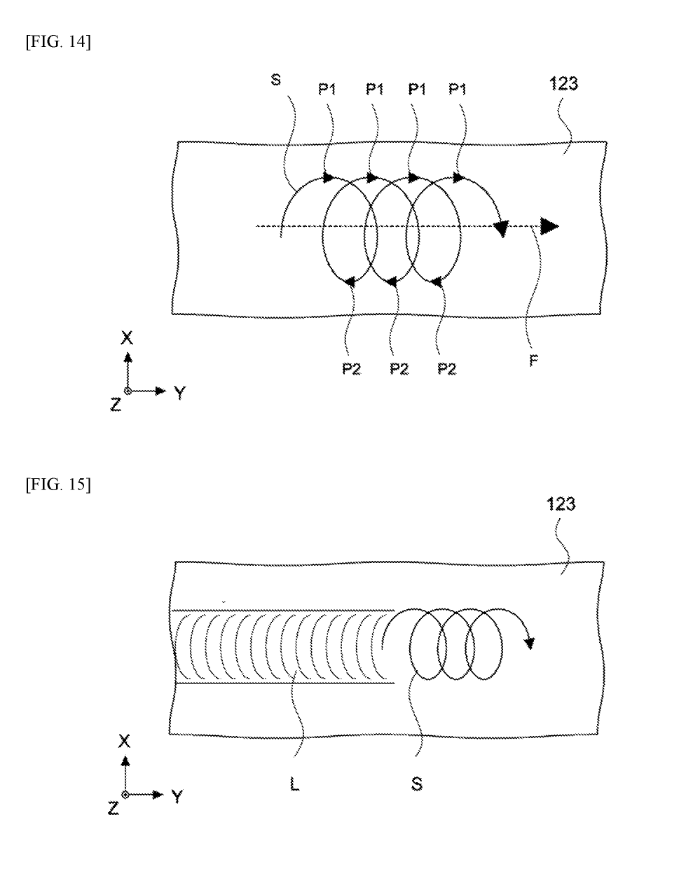

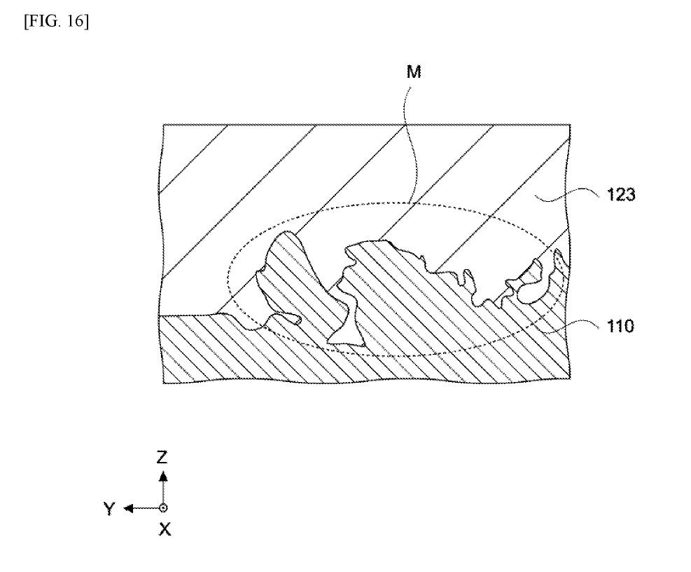

FIGS. 14 and 15 are schematic views showing laser scanning paths. As shown in these figures, the laser is irradiated onto the surface of the positive electrode tab 123 to perform scanning. Here, laser scanning is performed along a scanning path that draws a trajectory moving in the direction opposite the moving direction of the center.

FIG. 14 shows a laser scanning path S and a path F in which the center of the laser moves. Also, on the laser scanning path S, the direction identical to the path F is denoted by P1, while the direction opposite the path F is denoted by P2. As shown in the figure, laser scanning is performed along a scanning path that draws arcs in which the center of the arcs moves in one direction (path F), and the laser moves along the direction P2 in some parts of the scanning path S.

This way, a laser is irradiated on the same location on the positive electrode tab 123 several times, and as shown in FIG. 15, circular arc-shaped weld marks L that are arranged successively in one direction (path F) are formed as a result.

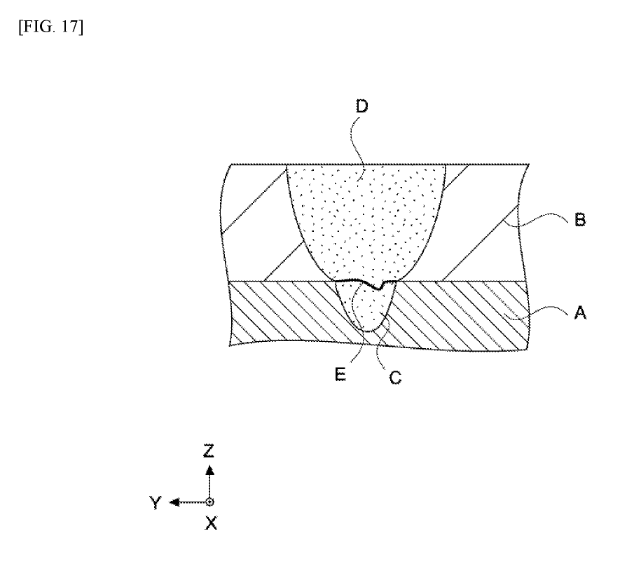

FIG. 16 is a schematic cross-sectional view of a location where a positive electrode tab 123 and a bus bar 110 are welded together. As shown in the figure, a mixed-material part M that has been generated by laser welding is formed at the interface between the positive electrode tab 123 and the bus bar 110. The mixed-material part M is where the constituent material of the positive electrode tab 123 and that of the bus bar 110 are mixed together.

On the other hand, FIG. 17 is a cross-sectional view showing weld marks that are left when a member A made of copper and a member B made of aluminum are welded together by means of general laser welding (point welding or line welding). As shown in the figure, a structurally altered part C where the structure of the member A has been altered due to the heat from welding, and a structurally altered part D where the structure of the member B has been altered due to the heat from welding, are formed in the welded location, and an intermetallic compound E which is a compound of the structurally altered part C and the structurally altered part D, is formed at the interface between the two parts. Because of this intermetallic compound E, the joining strength between the member A and the member B becomes insufficient.

On the other hand, performing laser welding along a scanning path that draws successive arcs, with the center of the arcs moving in one direction, not only increases the weld surface area, but it also causes the different types of metals to mix together and bond with each other in a complex manner. As a result, no intermetallic compound is produced at the interface and therefore an anchor effect generates. This makes it possible to achieve strong bonding, although alloying does not occur. It should be noted that the laser scanning path is not limited to the scanning path described above, and any scanning path may be set so long as a mixed-material part is formed by such laser scanning path that draws a trajectory moving in the direction opposite the moving direction of the center.

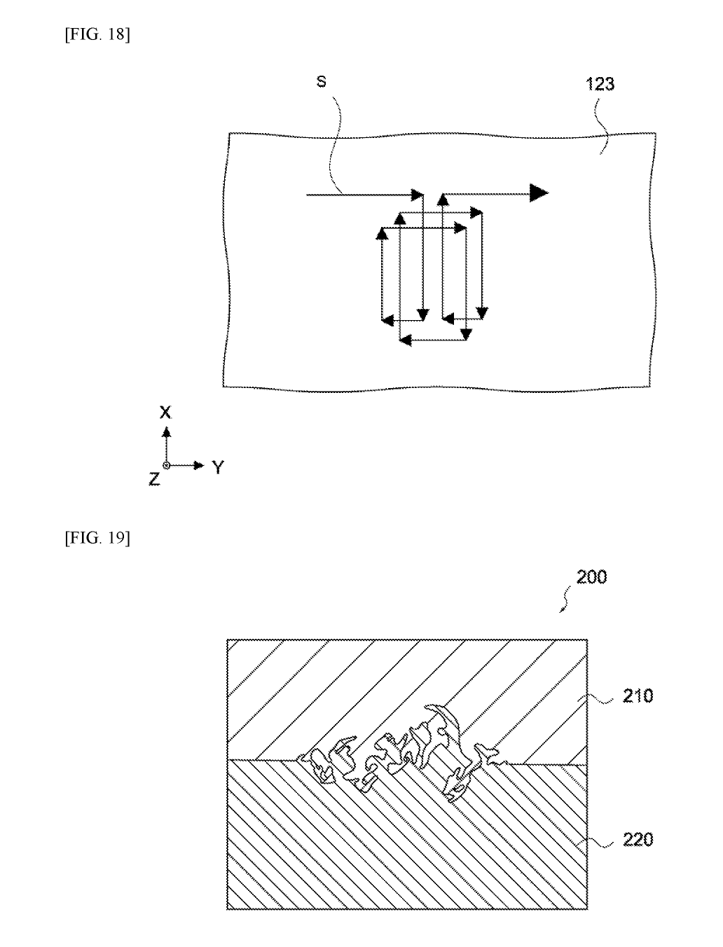

FIG. 18 shows another example of a laser scanning path. As shown in the figure, the laser scanning path S may be linear and may be a scanning path that draws a trajectory moving in the direction opposite the moving direction of the center of the laser, as well as in the direction orthogonal to the moving direction of the center of the laser. As the scanning path S is such that the laser moves in the direction orthogonal to the direction in which the center of the laser moves, an effect of increased weld surface area is achieved. In addition to the above, the laser scanning path may be a straight line along which the laser moves in one direction and in the opposite direction alternately.

The type of the laser used for the aforementioned laser welding is not limited in any way. However, a fiber laser is preferred because it can draw a continuous trajectory.

In addition, a strength check where a positive electrode tab 123 made of aluminum and a bus bar 110 made of copper were welded together and then pulled apart, found that the positive electrode tab 123 itself broke off but the welded part remained connected to the bus bar 110, confirming that the strength of the welded part was greater than the strength of the base material.

It should also be noted that, while the foregoing explained welding of a positive electrode tab 123 with a bus bar 110, a negative electrode tab 124 can also be welded with a bus bar 110, just like a positive electrode tab 123, using a laser. On the other hand, if the negative electrode tab 124 and bus bar 110 are made of the same type of metal material, they can be welded together using any general welding method, because intermetallic compound will not be formed.

It should also be noted that, while the foregoing explained a case where the constituent material of the positive electrode tab 123 was different from that of the bus bar 110, the aforementioned method can also be used to laser-weld a negative electrode tab 124 with a bus bar 110 whose constituent materials are different.

To be specific, consider a case involving a positive electrode tab 123 and a bus bar 110, both made of aluminum, and a negative electrode tab 124 made of copper. In this case, too, irradiating a laser onto the negative electrode tab 124 along any of the aforementioned scanning paths would form a mixed-material part between the negative electrode tab 124 and the bus bar 110, so that the two will be welded together to achieve sufficient joining strength between them. In addition to the above, the present invention can be applied to a case where the constituent material of at least one of the positive electrode tab 123 and the negative electrode tab 124 is different from the constituent material of the bus bar 110.

[Metal Joined Body]

While the foregoing explained laser-welding of a positive electrode tab or negative electrode tab with a bus bar in an electric storage module, this embodiment can also be used to join other metal members.

FIG. 19 is a cross-sectional view of a metal joined body 200 pertaining to this embodiment. As shown in the figure, the metal joined body 200 is constituted by a first member 210 and a second member 220 joined together.

The first member 210 is made of a first metal material, while the second member 220 is made of a second metal material which is different from the first metal material. The first metal material is a material whose melting point is lower than the melting point of the second metal material, so the first metal material may be aluminum (melting point: approx. 650° C.), while the second metal material may be copper (melting point: approx. 1050° C.).

The first member 210 and the second member 220 are joined together by means of laser welding, and as shown in FIG. 19, the second metal material penetrates into the first metal material in an irregular manner at the interface between the first member 210 and the second member 220.

The first member 210 and the second member 220 are welded together by holding the first member 210 and the second member 220 in contact with each other and irradiating a laser onto the first member 210 along a scanning path in which the center moves in one direction and which includes a path that moves in the direction opposite the moving direction of the center (refer to FIG. 14).

To be specific, the laser scanning path may be a scanning path that draws a trajectory moving in the direction opposite the moving direction of the center (refer to FIG. 15), or a linear scanning path that draws a trajectory moving in the direction opposite the moving direction of the center of the laser, as well as in the direction vertical to the moving direction of the center of the laser (refer to FIG. 18).

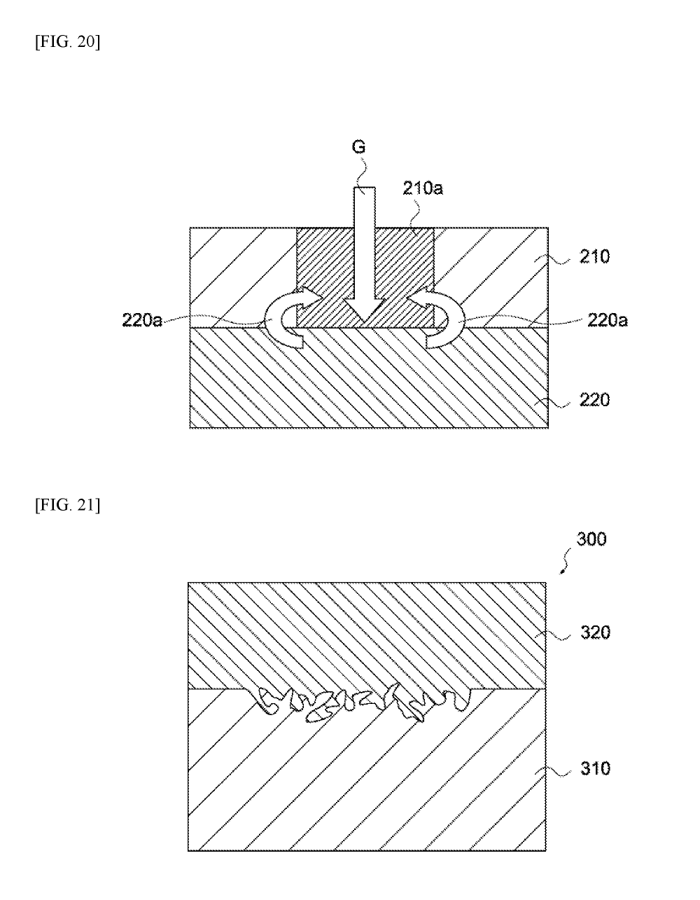

FIG. 20 is a schematic view showing a laser welding process. As shown in the figure, irradiating a laser G onto the first member 210 melts the first metal material, and a molten pool 210a is formed. At the same time, the surface layer part of the second metal material that has been softened or melted by the irradiated energy from the laser, rises in an irregular manner toward the molten pool 210a (arrows 220a in the figure) and flows into the molten pool 210a.

When the laser G stops irradiating, the first metal material and the second metal material solidify, and a structure constituted by the second metal material penetrating into the first metal material in an irregular manner is formed, as shown in FIG. 19. Because of this structure, an anchor effect generates between the first member 210 and the second member 220, and the two members are firmly joined together.

The laser G scanning path represents, as described above, a scanning path in which the center moves in one direction and which includes a path that moves in the direction opposite the moving direction of the center, and because of such scanning path, the molten pool 210a is agitated and the softened or molten surface layer of the second metal material rises. In contrast, general laser welding (point welding or line welding) does not agitate the molten pool 210a and therefore the second metal material does not rise.

It should also be noted that, while two metal members were joined together using a single laser scan in the foregoing explanation, two metal members can also be joined together using multiple laser scans. To be specific, a laser is irradiated onto the first member 210 to melt the first metal material, so that a molten pool 210a is formed, as shown in FIG. 18. As this happens, the second metal material softens in locations contacting the molten pool 210a of the second member 220.

Next, a second laser is irradiated onto the molten pool 210a, to agitate the molten pool 210a. This way, the softened second metal material is mixed into the molten pool 210a. When the laser stops irradiating, the first metal material and the second metal material solidify, and a structure constituted by the second metal material penetrating into the first metal material in an irregular manner is formed, as shown in FIG. 19. Because of this structure, an anchor effect generates between the first member 210 and the second member 220, and the two members are firmly joined together.

In the aforementioned constitution of the electric storage module 100, assume that the bus bar 110 is the second member 220, and either the positive electrode tab 123 or the negative electrode tab 124, whichever is made of a material different from the material of the bus bar 110, is the first member 210; in this scenario, the positive electrode tab 123 or negative electrode tab 124 and the bus bar 110 have lower contact resistance, and also improved joining strength, between them compared to when normal laser welding is used.

It should also be noted that, while a laser was irradiated onto the first metal material having a lower melting point in the foregoing explanation, a laser can also be irradiated onto the second metal material having a higher melting point. FIG. 21 is a cross-sectional view of a metal joined body 300 pertaining to this embodiment. As shown in the figure, the metal joined body 300 is constituted by a first member 310 and a second member 320 joined together.

The first metal material constituting the first member 310 is a material whose melting point is lower than the melting point of the second metal material constituting the second member 320, so the first metal material may be aluminum (melting point: approx. 650° C.), while the second metal material may be copper (melting point: approx. 1050° C.).

The first member 310 and the second member 320 are joined together by means of laser welding, and as shown in FIG. 21, the second metal material penetrates into the first metal material in an irregular manner at the interface between the first member 310 and the second member 320.

The first member 310 and the second member 320 are welded together by holding the first member 310 and the second member 320 in contact with each other and irradiating a laser onto the second member 320 along a scanning path in which the center moves in one direction and which includes a path that moves in the direction opposite the moving direction of the center (refer to FIG. 14).

To be specific, the laser scanning path may be a scanning path that draws a trajectory moving in the direction opposite the moving direction of the center (refer to FIG. 15), or a linear scanning path that draws a trajectory moving in the direction opposite the moving direction of the center of the laser, as well as in the direction orthogonal to the moving direction of the center of the laser (refer to FIG. 18).

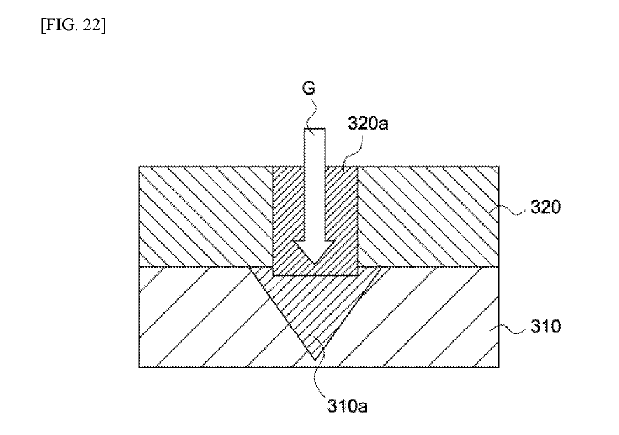

FIG. 22 is a schematic view showing a laser welding process. As shown in the figure, irradiating a laser G onto the second member 320 melts the second metal material constituting the second member 320, and a molten pool 320a is formed. Also, the first metal material constituting the first member 310 melts, and a molten pool 310a is formed. Now, because the melting point of the first metal material is lower than that of the second metal material, the viscosity of the molten pool 310a becomes lower than that of the molten pool 320a.

The second metal material is pushed by the laser into the molten pool 310a whose viscosity is lower, and flows into the molten pool 320a in an irregular manner. When the laser G stops irradiating, the first metal material and the second metal material solidify and a structure constituted by the second metal material penetrating into the first metal material in an irregular manner is formed, as shown in FIG. 21. Because of this structure, an anchor effect generates between the first member 310 and the second member 320, and the two members are firmly joined together.

The laser G scanning path represents, as described above, a scanning path in which the center moves in one direction and which includes a path that moves in the direction opposite the moving direction of the center. In the aforementioned constitution of the electric storage module 100, assume that the bus bar 110 is the first member 310, and either the positive electrode tab 123 or the negative electrode tab 124, whichever is made of a material different from the material of the bus bar 110, is the second member 320; in this scenario, the positive electrode tab 123 or negative electrode tab 124 and the bus bar 110 have lower contact resistance, and also improved joining strength, between them compared to when normal laser welding is used.

The type of the laser used for laser welding is not limited in any way. However, a fiber laser is preferred because it can be moved along a path consisting of successive shapes.

It should also be noted that, while welding was performed by means of laser irradiation in the foregoing explanation, the method need not be laser irradiation and any method may be used so long as it irradiates a high energy beam. For example, similar effects can also be achieved by irradiating an electron beam instead of a laser.

### DESCRIPTION OF THE SYMBOLS

10—Electric storage module
11—Frame
12—Electric storage cell
110—Bus bar
121—Electric storage element
122—Covering film
123—Positive electrode tab
124—Negative electrode tab
127—Positive electrode
128—Negative electrode
129—Separator
200—Metal joined body
210—First member
220—Second member
300—Metal joined body
310—First member
320—Second member

1. An electric storage module comprising:
an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; and
a frame that forms a housing space in which the electric storage cell is housed, and has a bus bar made of the second metal material;
wherein the positive electrode tab and the bus bar are joined to each other by means of welding, and a mixed-material part where the first metal material and the second metal material are mixed together is formed at an interface between the positive electrode tab and the bus bar.

2. An electric storage module comprising:
an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; and
a frame that forms a housing space in which the electric storage cell is housed, and has a bus bar made of the first metal material;
wherein the negative electrode tab and the bus bar are joined to each other by means of welding, and a mixed-material part where the first metal material and the second metal material are mixed together is formed at an interface between the negative electrode tab and the bus bar.

3. The electric storage module according to claim 1, wherein the first metal material is aluminum, and the second metal material is copper.

4. A manufacturing method for an electric storage module comprising:
housing an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar; and
irradiating a high energy beam onto the positive electrode tab along a scanning path in which the center moves in one direction and which includes a path that moves in a direction opposite a moving direction of the center, to weld the positive electrode tab to the bus bar.

5. A manufacturing method for an electric storage module comprising:
housing an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar; and
irradiating a high energy beam onto the positive electrode tab along a scanning path that draws arcs in which a center of the arcs moves in one direction, to weld the positive electrode tab to the bus bar.

6. A manufacturing method for an electric storage module comprising:
housing an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the first metal material, in such a way that the negative electrode tab contacts the bus bar; and
irradiating a high energy beam onto the negative electrode tab along a scanning path in which the center moves in one direction and which includes a path that moves in a direction opposite a moving direction of the center, to weld the negative electrode tab to the bus bar.

7. A manufacturing method for an electric storage module comprising:
housing an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the first metal material, in such a way that the negative electrode tab contacts the bus bar; and
irradiating a high energy beam onto the negative electrode tab along a scanning path that draws arcs in which a center of the arcs moves in one direction, to weld the negative electrode tab to the bus bar.

8. The manufacturing method for an electric storage module according to claim 1, wherein the high energy beam is a light irradiated from a fiber laser.

9. A metal joined body comprising:
a first member made of a first metal material; and
a second member made of a second metal material which is different from the first metal material;
wherein the first member and the second member are joined to each other by welding, and at an interface between the first member and the second member, the second metal material penetrates into the first metal material in an irregular manner.

10. The metal joined body according to claim 9, wherein the first metal material is a metal material whose melting point is lower than a melting point of the second metal material.

11. The metal joined body according to claim 10, wherein the first metal material is aluminum, and the second metal material is copper.

12. A manufacturing method for a metal joined body comprising:
holding a first member made of a first metal material, and a second member made of a second metal material which is different from the first metal material, in contact with each other; and
irradiating a high energy beam onto the first member along a scanning path such that a center of the high energy beam moves forward by alternately advancing and retracting wherein the scanning path includes a path in which the center moves in one direction and a path in which the center moves in a direction opposite the one direction of the center, to weld the first member to the second member.

13. The manufacturing method for a metal joined body according to claim 12, wherein, in the step to weld the first member to the second member, a high energy beam is irradiated onto the first member along a scanning path that draws arcs in which a center of the arcs moves in one direction.

14. The manufacturing method for the metal joined body according to claim 12, wherein the first metal material is a metal material whose melting point is lower than a melting point of the second metal material.

15. The manufacturing method for a metal joined body according to claim 12, wherein the high energy beam is a light irradiated from a fiber laser.

16. A manufacturing method for an electric storage module comprising:
housing an electric storage cell, comprising: an electric storage element having a positive electrode and a negative electrode; a covering film that, together with an electrolyte, seals the electric storage element; a positive electrode tab made of a first metal material and electrically connected to the positive electrode; and a negative electrode tab made of a second metal material and electrically connected to the negative electrode; in a frame having a bus bar made of the second metal material, in such a way that the positive electrode tab contacts the bus bar;
irradiating a high energy beam onto the positive electrode tab to form, on the positive electrode tab, a molten pool constituted by the first metal material in molten state, and also to soften the second metal material in locations of the bus bar where it contacts the molten pool; and
irradiating a high energy beam onto the positive electrode tab to agitate the molten pool, and mix the softened second metal material into the molten pool.

17. A manufacturing method for a metal joined body comprising:
holding a first member made of a first metal material, and a second member made of a second metal material of a second metal material which is different from the first metal material, in contact with each other;
irradiating a high energy beam onto the first member to form, on the first member, a molten pool constituted by the first metal material in molten state, and also to soften the second metal material in locations of the second member where it contacts the molten pool; and
irradiating a high energy beam onto the first member to agitate the molten pool, and mix the softened second metal material into the molten pool.

18. The metal joined body according to claim 9, wherein the second metal material forms irregular protrusions in irregular directions along the interface.
